(19) United States
(12) Patent Application Publication
(10) Pub. No.: US 2017/0140646 A1
(43) Pub. Date: May 18, 2017

(54) IN-VEHICLE GARAGE DOOR MONITOR

(71) Applicants: Jiang Lu, Arvada, CO (US); Fangqin Liu, Arvada, CO (US)

(72) Inventors: Jiang Lu, Arvada, CO (US); Fangqin Liu, Arvada, CO (US)

(21) Appl. No.: 15/340,738

(22) Filed: Nov. 1, 2016

Related U.S. Application Data
(60) Provisional application No. 62/255,863, filed on Nov. 16, 2015.

(51) Int. Cl. G08G 1/0962

(52) U.S. Cl. CPC G08G 1/0962

(57) ABSTRACT

An in-vehicle garage door monitoring system. An example monitoring system includes a sensor mounted near a garage door to determine a status of the garage door. The example monitoring system also includes a transmitter mounted near the garage door and communicatively coupled with the sensor, the transmitter issuing a signal corresponding to the status of the garage door. The example monitoring system also includes a receiver at the vehicle to receive the signal from the transmitter, the receiver issuing at least one notification to an occupant of the vehicle indicating the status of the garage door.

### PRIORITY CLAIM

This application claims the priority benefit of U.S. Provisional Patent Application No. 62/255,863 filed Nov. 16, 2015 titled “In-Vehicle Garage Door Monitor” of Jiang Lu and Fangqin Liu, hereby incorporated by reference for everything that is disclosed as though fully set forth herein.

### BACKGROUND

People sometimes drive their vehicles away from home, forgetting to close their garage door. Sometimes, they have closed their garage door but still wonder whether they closed the garage door after they are out of sight of the garage door. These situations may occur more frequently as people get older or their lives get busier.

### BRIEF DESCRIPTION OF THE DRAWINGS

FIG. 1 shows an example in-vehicle garage door monitor, wherein a garage is shown with the garage door closed.

FIG. 2 shows an example in-vehicle garage door monitor, wherein a garage is shown with the garage door open.

FIG. 3 shows an example in-vehicle garage door monitor as a sensor and transmitter may be mounted on near a front of the garage.

FIG. 4 is a circuit diagram for an example transmitter of the in-vehicle garage door monitor.

FIG. 5 is a circuit diagram for another example transmitter of the in-vehicle garage door monitor.

FIG. 6 is a circuit diagram for an example receiver of the in-vehicle garage door monitor.

FIG. 7 is a circuit diagram for another example receiver of the in-vehicle garage door monitor.

FIG. 8 is a flow chart showing example operations to generate a signal for the in-vehicle garage door monitor.

FIGS. 9A-9B are flow charts showing example operations to generate output based on a signal for the in-vehicle garage door monitor.

### DETAILED DESCRIPTION

A garage door monitor is disclosed which may be implemented “in-vehicle” to inform or alert occupants of a vehicle as to the status of a garage door when the occupants are leaving the garage in their vehicle.

In an example, the garage door monitor includes a transmitter in or near the garage, and a receiver in or on the vehicle. The transmitter at the garage issues a signal to the receiver at the vehicle. The receiver then issues an alert or otherwise notifies the driver or other user of a status of the garage door (e.g., open or closed).

The range of wireless communication between the transmitter and the receiver may be limited (e.g., to about a hundred yards or less) to reduce impact on its electromagnetic environment.

In an example, range of the transmitter is limited by wireless transmission power of the transmitter. As such, the system disclosed herein is practical for use as an in-vehicle garage door monitor because it can set off an alarm at the edge or “rim” of the wireless transmitting range if the garage door is open before the vehicle travels too far away.

The garage door monitor enables in-vehicle, garage door monitoring so that the user does not leave (or go too far) without closing the garage door. The garage door monitor also provides peace of mind in knowing that the garage door is closed even when an occupant of the vehicle can no longer see the garage door.

In an example, the garage door monitor checks the wireless signal when the vehicle engine is started to determine whether the monitoring system is working (e.g., that the transmitter has not failed due to battery drain) before the vehicle leaves the garage or travels too far from the garage door (e.g., out of range of the transmitter).

The garage door monitor may set off an alarm and alert the vehicle occupants if the garage door is still open before the vehicle moves out of the wireless transmission range of the transmitter.

In an example, the wireless transmission range may be limited, so that the vehicle occupants can be alerted to the status of their garage door while the vehicle is still in the vicinity of the garage. For example, the garage door monitor may alert the driver or other user that the garage door is open before the vehicle has left the neighborhood, so that the driver can return to the house and close the garage door before they have driven too far away.

In addition, the garage door monitor can alert the driver or other user that the garage door is still open, even when the vehicle has moved out of the wireless transmission range of the transmitter. For example, the garage door monitor can monitor for a loss of a wireless signal from the transmitter as an indicator of the vehicle being out-of-range. If the last signal received from the transmitter indicates that the garage door is still open, this information along with the out-of-range determination, may be implemented to issue an alert or other notification to the driver or other user even when the vehicle is out-of-range. That is, the garage door monitor may set off an alarm when the garage door is open and the vehicle carrying the receiver is moving or has moved out of the wireless communication range.

In an example, the transmitter is weatherproof for mounting on the outside of the garage. The receiver and the transmitter can be installed and/or serviced with little effort.

In an example, the receiver may be powered by batteries, the vehicle battery (e.g., via the power adapter or “cigarette lighter”), and/or solar energy (e.g., available on the vehicle dashboard or other suitable location).

In an example, transmitter may utilize the household electrical system, a separate battery, and/or solar energy (e.g., positioned outside the garage or other suitable location). By removing the battery from the transmitter itself, the garage door monitor can be provided in a sealed enclosure (e.g., without the access opening for battery change), and also enables a maintenance-free transmitter. The transmitter can be attached to the garage door with sticky tape. As such, the garage door monitor benefits from simplified construction, weatherproofing, and simplified installation.

Before continuing, it is noted that as used herein, the terms “includes” and “including” mean, but is not limited to, “includes” or “including” and “includes at least” or “including at least.” The term “based on” means “based on” and “based at least in part on.”

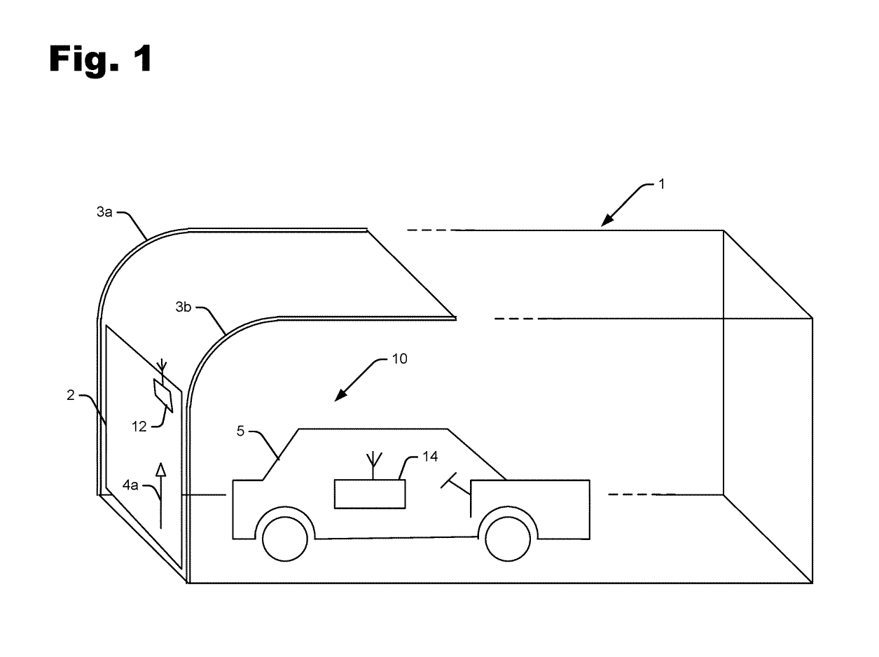

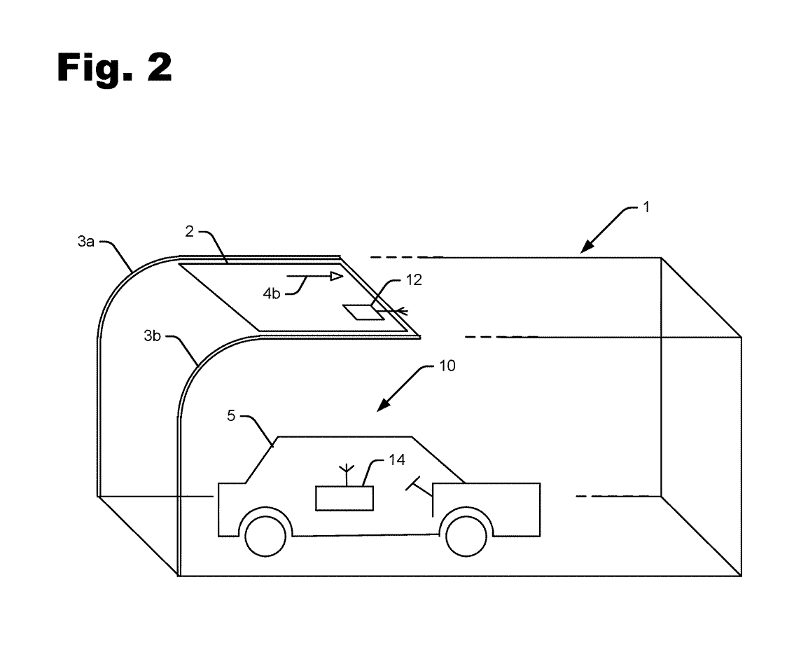

FIG. 1 shows an example in-vehicle garage door monitor 10, wherein a garage 1 is shown with the garage door 2 in a closed position. FIG. 2 shows an example in-vehicle garage door monitor 10, wherein a garage 1 is shown with the garage door 2 in an open position.

Rails 3a and 3b for the garage door 2 are shown to move between the open and closed positions. The arrows 4a and 4b indicate the orientations of the garage door 2. A vehicle 5 is shown parked in the garage 1. An example of the garage door monitor 10 includes a transmitter 12 and a receiver 14.

The transmitter 12 is shown in this example as it may be mounted on the outside, upper section of the garage door 20. The receiver 14 is shown in this example as it may be placed inside the vehicle 5. However, the garage door monitor 10 is not limited to any particular location of the transmitter 12 and receiver 14, other than the transmitter should generally be positioned at the garage 1 and the receiver should generally be positioned at the vehicle 5.

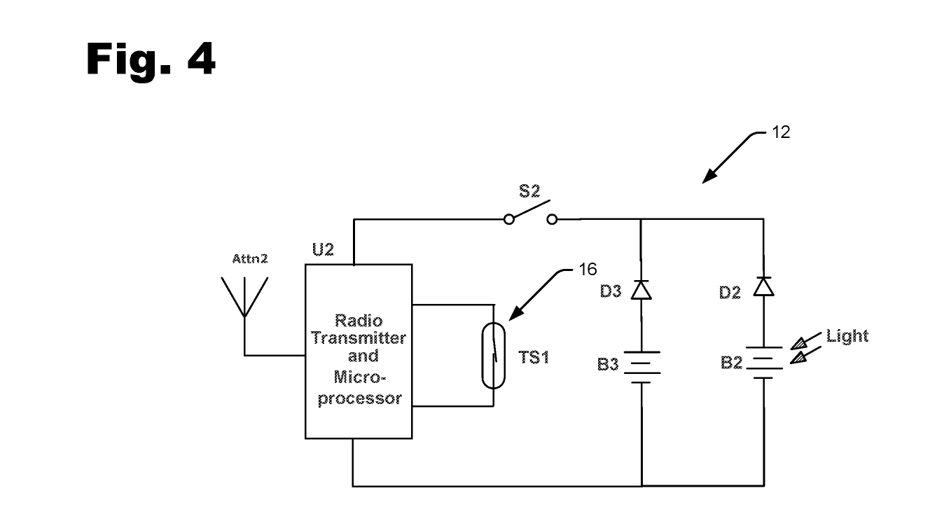

The transmitter 12 is associated with a sensor 16 (not shown in FIG. 1 and FIG. 2; see, e.g., FIG. 4). The sensor 16 determines a status (e.g., a position and/or orientation) of the garage door 2. The transmitter 12 issues a signal based on the status, to the receiver 14. For example, the transmitter may issue the signal via Radio Frequency (RF) or other wireless transmission protocol. The receiver 14 receives the signal so that the garage door monitor 10 can issue an alert or other notification “in-vehicle” (e.g., to an occupant of the vehicle 5) as to the status of the garage door 2.

In an example, the transmitter 12 is constructed as a single piece. As such, installation can be as simple as sticking the transmitter 12 onto the garage door 2 with a piece of double-stick tape.

In an example, sensor 16 is a tilt sensor configured to determine orientations of the garage door 2. In this example, the upper section of the garage door 2 is not in a fully vertical position until the garage door 2 is fully closed. As such, the garage door 2 is considered by the garage door monitor 10 to be open until the garage door 2 is fully closed.

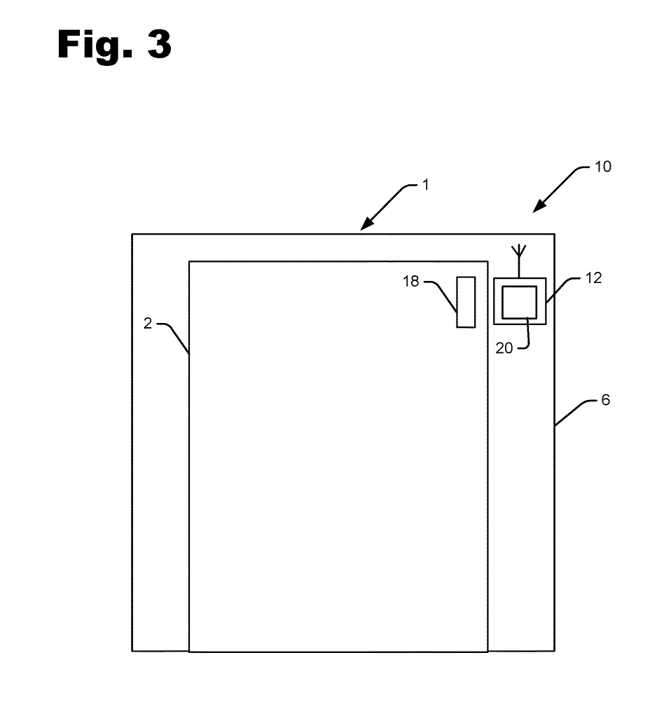

It is noted, however, that any suitable type (and number) of sensor 16 may be implemented for the garage door monitor 10. Other examples include, but are not limited to a Hall Effect Detector, described with reference to FIG. 3.

Before continuing, it should be noted that the examples described above are provided for purposes of illustration, and are not intended to be limiting. Other components and/or configurations may be utilized to carry out the operations described herein.

FIG. 3 shows an example in-vehicle garage door monitor 10 as a sensor may be mounted on near a front of the garage 1. FIG. 3 illustrates a front of the garage 1 with a door frame 10 around the garage door 2. In this example, the sensor includes a magnet 18 mounted on the garage door 2 and a Hall Effect Detector 20 mounted on the door frame 6. The Hall Effect Detector 20 generates output based on presence or absence of the magnet 18. The transmitter 12 receives the output from the Hall Effect Detector 20 and generates a signal based on a position of the magnet 18 to indicate the status (e.g., open or closed) of the garage door 2.

In an example, the magnet 18 is mounted on the upper corner section of the garage door 2, and the Hall Effect Detector 20 is mounted on the garage door frame 6 adjacent to the magnet 18 when the garage door 2 is fully closed. The Hall Effect Detector 20 may be part of or at least communicatively coupled to the transmitter 12.

When the garage door 2 is fully closed, the magnet 18 is in a vicinity of the transmitter 12 on the garage door frame 6, and the presence of magnet 18 is detected by the Hall Effect Detector 20. Thus, output from the Hall Effect Detector 20 indicates that the garage door 2 is fully closed.

When the garage door 2 is in any other position (e.g., partly or fully open), the magnet 18 is not detected by the Hall Effect Detector 20. Therefore, output by the Hall Effect Detector 20 (and hence the transmitter 12), indicates that the garage door 2 is not fully closed (e.g., partly or fully open).

FIG. 4 is a circuit diagram for an example transmitter 12 of the in-vehicle garage door monitor 10. In this example, the transmitter 12 is associated with a sensor 16 configured as a tilt sensor TS1 to detect orientation of the garage door 2. In the example illustrated, the tilt sensor TS1 is attached to the garage door 2 and thus can detect orientation of the garage door 2.

In the circuit diagram shown in FIG. 4, Atten2 is a wireless antenna, and U2 is the radio transmitter and microprocessor (e.g., Si4010-C2 chip from Silicon Labs, although other radio transmitter and microprocessor can be used). In the circuit diagram, B2 is a solar battery, and B3 is a coin-cell battery for backup of B2 (which may be omitted without affecting the function of the transmitter 12). In the circuit diagram, D2 and D3 isolate the batteries B2 and B3 from each other. In the circuit diagram, S2 is a switch for turning off the battery powers.

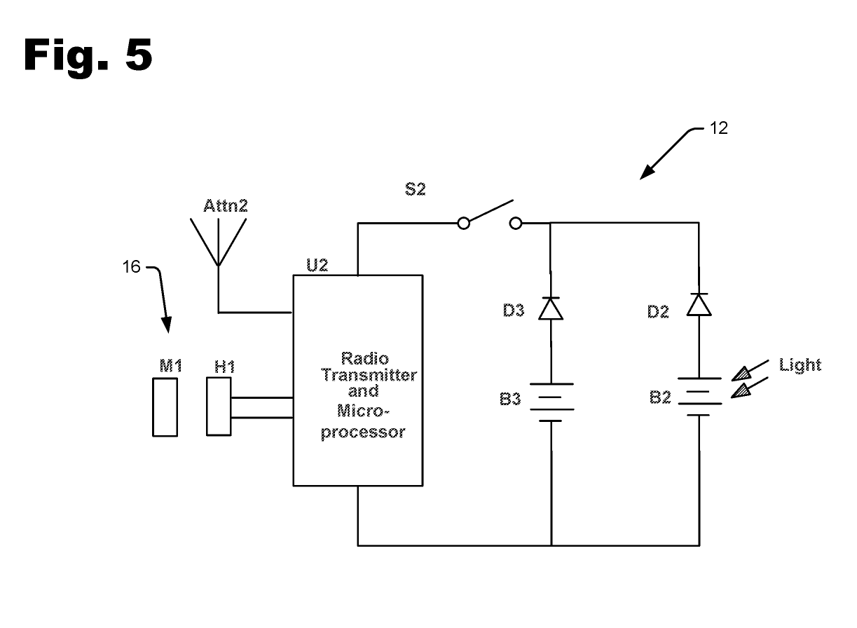

FIG. 5 is a circuit diagram for another example transmitter 12 of the in-vehicle garage door monitor 10. In this example, the transmitter 12 is associated with a sensor 16 configured as a magnet M1 and a Hall Effect Detector H1 to determine position of the garage door 2. In an example, the Magnet M1 may be mounted on the garage door 2, and the Hall Effect Detector H1 is mounted on the garage door frame 6. Hall Effect Detector H1 detects presence of the Magnet M1.

In the circuit diagram, Atten2 is a wireless antenna. In the circuit diagram, U2 is the radio transmitter and microprocessor (e.g., Si4010-C2 chip from Silicon Labs, although other radio transmitter and microprocessor can be used). In the circuit diagram, B2 is a solar battery, and B3 is a coin-cell battery for backup of B2 (which may be omitted without affecting the functions of the transmitter 12). In the circuit diagram, D2 and D3 isolate the batteries B2 and B3 from each other. In the circuit diagram, S2 is a switch for turning off the battery powers.

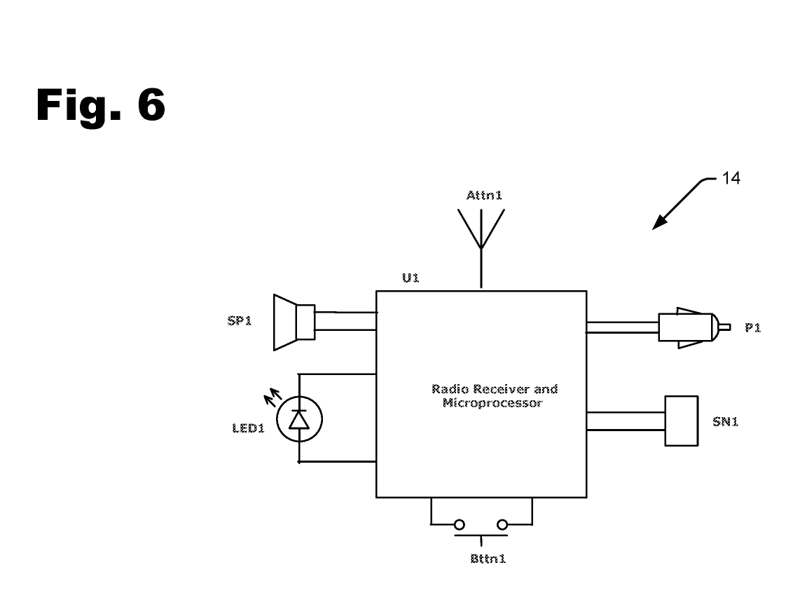

FIG. 6 is a circuit diagram for an example receiver 14 of the in-vehicle garage door monitor 10. The example circuit receives DC power from a cigarette lighter adapter plug in a vehicle equipped with the cigarette lighter receptacle. A vehicle cigarette lighter adaptor P1 may be connected or plugged into the vehicle electrical connection (e.g., cigarette lighter receptacle) to draw DC electrical power from the vehicle battery. Wireless antenna Atten1 receives radio signals transmitted by the transmitter. The radio receiver U1 receives radio signals from the transmitter and the microprocessor processes the received radio signals. In an example, the circuit implements a Si4313 radio receiver chip and C1251F912 microprocessor chip from Silicon Labs. Other radio receiver and microprocessor chips can be used.

In the circuit diagram, SP1 is a buzzer or other sound transducer for generating sound, and LED1 is an LED for generating light. More than one LED can be used for generating complex light patterns. Together with the buzzer SP1 and LED LED1, the circuit can generate different audio and/or visual output to inform and alert the user of the status of the garage doors. Button Bttn1 enables a user to interact with the receiver, for example, to turn off the alarm.

In the circuit diagram, SN1 is a sensor such as the vibration sensor or other types of sensors to monitor whether the vehicle engine is running. SN1 sensor input services two functions. First, sensor SN1 turns off the electronics (or puts the electronics into low energy consumption mode) when the vehicle engine is not running. For example, this may occur when the vehicle is parked in the garage during the night to save the battery energy. Second, sensor SN1 wakes up the electronics and initiates the searching of registered transmitters.

There are two cases that the receiver may fail to receive the radio signals from the transmitter 12. One case is when the receiver 14 is out of transmission range of the transmitter 12 (e.g., when the vehicle 5 with the receiver 14 is driven away). In this case, the receiver 14 alerts the user with the last known status of the garage door 2 (e.g., open or closed). The other case is when the transmitter 12 fails (e.g., due to the battery draining). In this case, if the receiver 14 uses the last known status of the garage door (e.g., open, when the garage door is actually closed), it could falsely notify the user of the garage door status. In an example, the garage door monitor 10 addresses these cases by confirming operation of registered transmitter(s) 12 when the vehicle engine is started, before the vehicle leaves the garage so that the user can address the issue without receiving false notifications as to the garage door status.

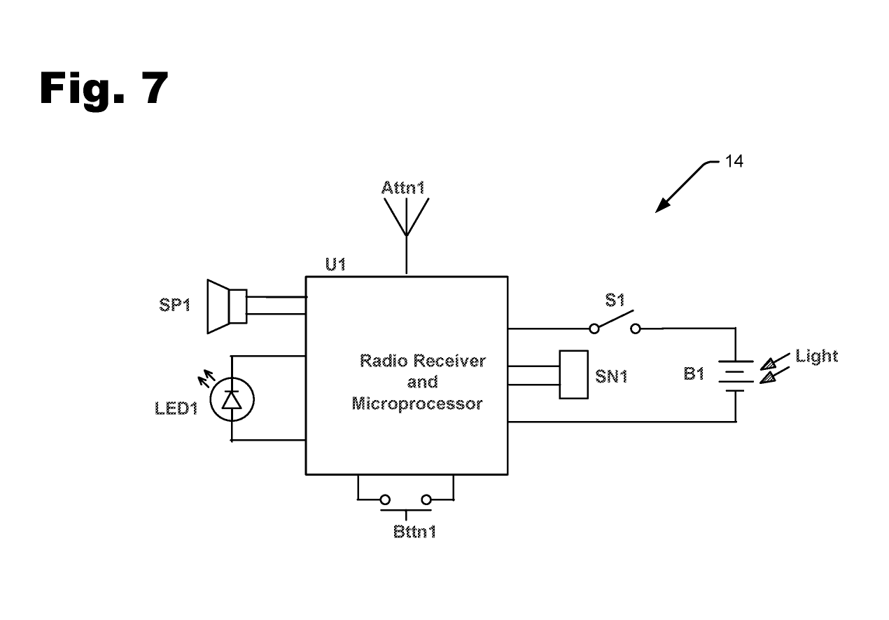

FIG. 7 is a circuit diagram for another example receiver 14 of the in-vehicle garage door monitor 10. The example circuit receives DC power from a solar battery. The circuit implements a solar battery B1 to power the receiver electronics. The solar battery B1 may be placed near the vehicle windshield to receive the solar energy. The remaining electronic components in the circuit are the same as those already described for FIG. 6.

Although specific circuits are shown in the drawings for purposes of illustration, the garage door monitor 10 is not limited to any particular circuit(s). It will be readily apparent to those having ordinary skill in the art that other circuits may also be implemented to achieve various aspects of the garage door monitor 10 described herein.

It is noted that the garage door monitor 10 disclosed herein is easy to install, can be operated out-of-the-box, and is substantially maintenance-free. For example, the device implements solar energy and/or cigarette lighter socket of a vehicle to power the devices. Even the coin-cell battery can be sealed into the device for one-time use and for weather-proofing. In addition, the device can be dedicated to in-vehicle use. One of the reasons we don't see in-vehicle garage door monitor devices in market is because the current state of the art devices do not work well for in-vehicle use application. Not just because the hardware is not fit, but because the program code is not well defined.

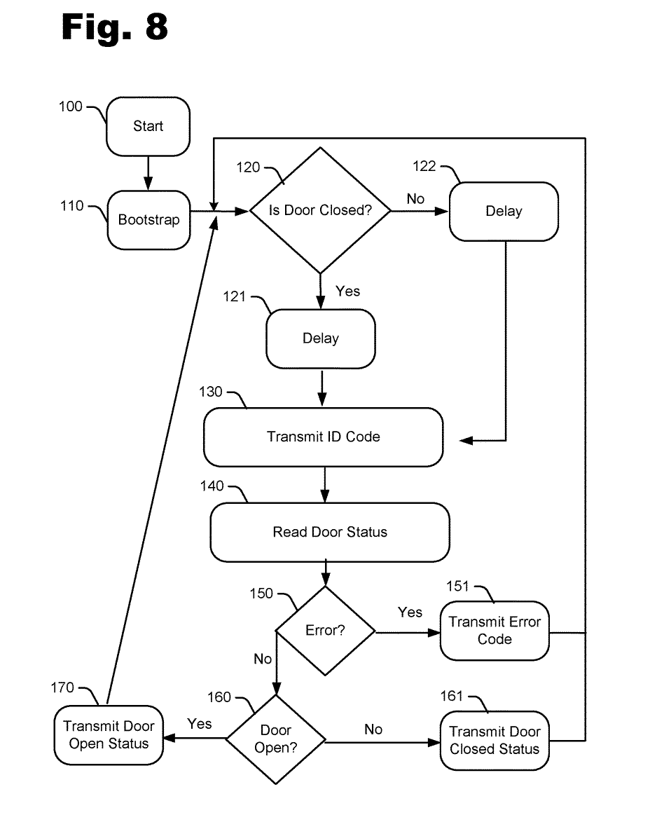

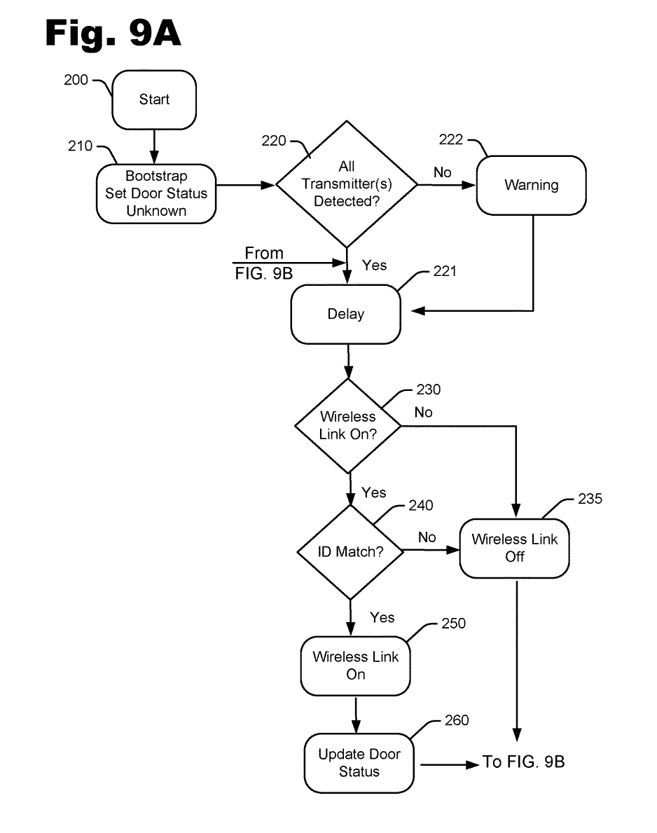

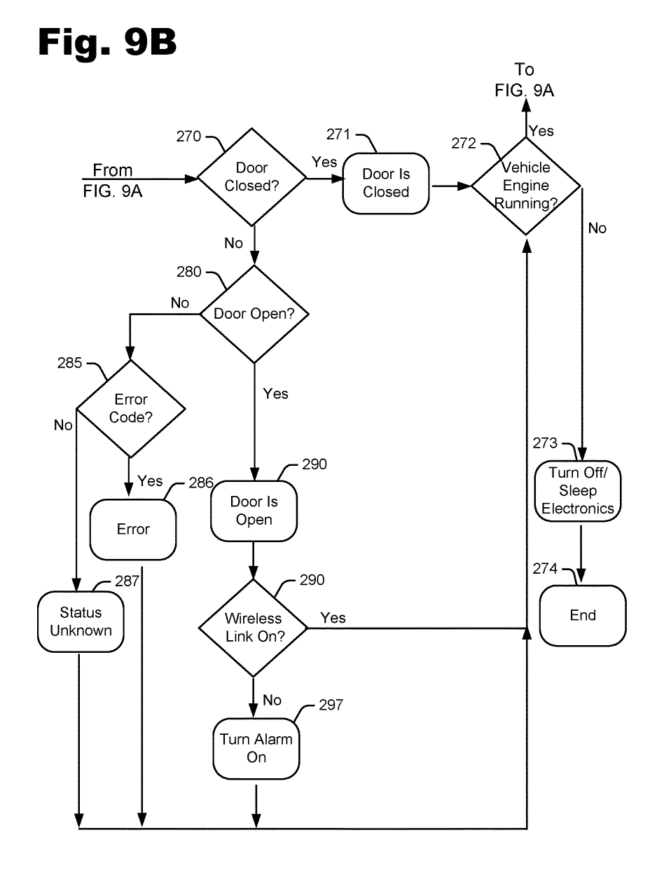

FIGS. 8 and 9 illustrate example operations which may be implemented by the garage door monitor 10. The operations may be embodied, at least in part, as program code stored in memory and executable by a microprocessor. The operations shown and described herein are provided to illustrate example implementations. It is noted that the operations are not limited to the ordering shown. Still other operations (not shown) may also be implemented, as will be readily apparent to those having ordinary skill in the art after becoming familiar with the teachings herein.

FIG. 8 is a flow chart showing example operations to generate a signal for the in-vehicle garage door monitor. Operations start at 100. The program code bootstraps at 110. A determination is made at 120 whether the garage door is closed. If the garage door is closed, a delay 121 is entered and then operations proceed to operation 130. If the garage door is not closed (e.g., partially or fully open), a delay 122 is entered, and then operations proceed to operation 130.

At operation 130, an identification (ID) code is transmitted. The door status is read at operation 140. A determination 150 is made whether there is an error. If there is an error, an error code is transmitted at 151. Monitoring operations may continue by returning to determination 120.

If there is not an error at determination 150, then a determination 160 is made whether the door is open. If the door is not open, then a door closed status is transmitted. Otherwise, if the door is open at determination 160, then a door open status is transmitted 170. Monitoring operations may continue by returning to determination 120.

By way of illustration, the operations described above read the garage door status and transmits the status in radio signals. The garage door status can be detected by any suitable means (e.g., a tilt sensor, a Hall Effect sensor).

The delay regulates the status transmission rate (e.g., shown implementing two separate delays). The user typically does not need to monitor the status of the garage door when it is closed (e.g., when the user has already been away from the garage or during the night). As such, the operations may implement a longer delay time when the garage door is closed. This helps to reduce the transmission rate and save battery or other electric power.

The operations also transmit an identification (ID) for identifying self-exclusivity. The ID may be registered with the receiver to monitor several transmitters (e.g., mounted on different garage doors). Likewise, a transmitter can be monitored by several receivers in different vehicles. If the transmitter fails to identify the garage door status for any reason, the transmitter may issue an error code to the receiver. This ID system enables the monitor to monitor several garage doors, for example a house with 3-car garage usually has two garage doors, while not be confused by signals coming from neighbors' garage doors. This feature is also specifically designed for in-vehicle application.

FIGS. 9A-9B are flow charts showing example operations to generate output based on a signal for the in-vehicle garage door monitor. Operations start at 200. The program code bootstraps at 210, and the door status is set to “unknown.” In operation 220, a determination is made whether all transmitter(s) are detected. If not, a warning 222 may be issued.

If all transmitters are detected at 220, operations are delayed 221, and a determination 230 is made whether a wireless link (e.g., RF link) is on. If the wireless link is not on, a status is set that the wireless link is off at 235, and operations continue to operation 270 (FIG. 9B).

If the wireless link is determined to be on at operation 230, then a determination 240 is made whether there is an ID match for the wireless link. If there is no ID match, operations proceed to 235 and 270 as already described above. If there is an ID match at 240, a status is set that the wireless link is on at 250, and the door status is updated at 260.

Continuing with operations shown in FIG. 9B, a determination 270 is made whether the door is closed. If the door is closed 271, then another determination 272 is made whether the vehicle is running. If the vehicle is running, then operations return the operations shown in FIG. 9A, as illustrated in FIG. 9B. If the car is not running, then the electronics may be powered off or entered in a sleep mode 273. Operations then end at 274.

If the door is not closed at determination 270, another determination 280 is made whether the door is open. If the door is not open, a determination 285 is made whether there is an error code. If there is an error code 286, then operations proceed to 272 and continue as already described above. Otherwise, if there is no error code at determination 285, then the status of the garage door is set to “unknown” 287, and operations proceed to 272 and continue as already described above.

If the door is open at determination 280, then the door is open 290 and a determination 295 is made whether the wireless link is on. If the wireless link is on, then operations proceed to 272 and continue as already described above. Otherwise, if the wireless link is not on, then an alarm may be activated 297, and operations proceed to 272 and continue as already described above.

By way of illustration, after exiting the Bootstrap, the operations first check if registered transmitter(s) are detected. Operations may alert the user if all transmitters are not found. This operation helps prevent the receiver from providing false information during the intended applications.

The receiver may alert the user to a status of the garage door when the vehicle that carries the receiver is driven out of the wireless transmission range of the transmitter (e.g., using the status received before the receiver is out of the wireless range of the transmitter). As such, operations may confirm that the transmitters that the receiver is monitoring are all functioning while the receiver is still in wireless range of the transmitter (e.g., when the receiver “wakes up” when the vehicle is started and has not left the garage yet).

After presence of the transmitter(s) is confirmed, the receiver treats the loss of the radio link to each individual transmitter as though that transmitter is out of wireless range.

The delay operation regulates the rate of the loop. The operations continue detecting the presence of a radio link to each transmitter, and may inform the user of the radio link status.

In an example, the operations also verify the ID of received transmitter signals, and may ignore those transmitters that have not been registered with the receiver. If there is a match with the stored transmitter IDs, the operations may update the garage door status. Otherwise, the stored status may be provided for processing in later operations.

The operations shown and described herein are provided to illustrate example implementations. For example, the status unknown indication and the error indication can be combined to simplify the indication patterns. The program may have any of a variety of different configurations to achieve the same or similar results, as will be readily understood by those having skill in the art after becoming familiar with the teachings herein.

It is noted that the examples shown and described are provided for purposes of illustration and are not intended to be limiting. Still other examples are also contemplated.

1. An in-vehicle garage door monitor to inform or alert an occupant of a vehicle as to a status of a garage door, comprising:
a sensor to determine a status of the garage door;
a transmitter issuing a signal corresponding to the status of the garage door; and
a receiver at the vehicle to receive the signal from the transmitter, the receiver issuing a notification to the occupant of the vehicle as to the status of the garage door.

2. The in-vehicle garage door monitor of claim 1, wherein the sensor is a tilt-sensor.

3. The in-vehicle garage door monitor of claim 1, further comprising a processor communicatively coupled to the transmitter.

4. The in-vehicle garage door monitor of claim 3, wherein the processor receives input from the sensor and generates the signal.

5. The in-vehicle garage door monitor of claim 3, wherein range of the transmitter is limited by wireless transmission power of the transmitter.

6. The in-vehicle garage door monitor of claim 1, further comprising a processor communicatively coupled to the receiver.

7. The in-vehicle garage door monitor of claim 6, wherein the processor checks a status of the transmitter when an engine of the vehicle is started.

8. The in-vehicle garage door monitor of claim 6, wherein the processor generates a signal indicating that the garage door is open and the vehicle is one of within a communication range of the garage door.

9. The in-vehicle garage door monitor of claim 6, wherein the processor generates a signal indicating that the garage door is open and the vehicle is out of a communication range of the garage door.

10. The in-vehicle garage door monitor of claim 1, further comprising an identification (ID) to enables monitoring several garage doors at a single location, without confusing a neighbor garage door.

11. An in-vehicle garage door monitoring system, comprising:
a sensor mounted near a garage door to determine a status of the garage door;
a transmitter mounted near the garage door and communicatively coupled with the sensor, the transmitter issuing a signal corresponding to the status of the garage door; and
a receiver at the vehicle to receive the signal from the transmitter, the receiver issuing at least one type of notification to an occupant of the vehicle identifying the status of the garage door.

12. The in-vehicle garage door monitor of claim 11, further comprising a first processor communicatively coupled to the transmitter, the processor receiving input from the sensor and generating the signal.

13. The in-vehicle garage door monitor of claim 12, wherein the processor limits range of the transmitter.

14. The in-vehicle garage door monitor of claim 12, further comprising a second processor communicatively coupled to the receiver, the second processor checking a status of the transmitter when an engine of the vehicle is started.

15. The in-vehicle garage door monitor of claim 14, wherein the second processor generates a signal indicating a first type of notification that the garage door is open and the vehicle is within a communication range of the garage door.

16. The in-vehicle garage door monitor of claim 11, further comprising an identification (ID) to enables monitoring several garage doors at a single location, without confusing a neighbor garage door.

17. The in-vehicle garage door monitor of claim 16, wherein the second processor generates a signal indicating a third type of notification indicating that the garage door is open and the vehicle is out of a communication range of the garage door.

18. An in-vehicle garage door monitoring system, comprising:
a sensor mounted near a garage door to determine a status of the garage door;
a transmitter mounted near the garage door and communicatively coupled with the sensor, the transmitter issuing a signal corresponding to the status of the garage door; and
a receiver at the vehicle to receive the signal from the transmitter, the receiver issuing at least one notification to an occupant of the vehicle, the notification indicating at least one of:
the garage door is open and the vehicle is within a communication range of the garage door; and
the garage door is open and the vehicle is out of a communication range of the garage door.

19. The in-vehicle garage door monitor of claim 18, further comprising a first processor communicatively coupled to the transmitter, the processor receiving input from the sensor and generating the signal.

20. The in-vehicle garage door monitor of claim 19, further comprising a second processor communicatively coupled to the receiver, the second processor checking a status of the transmitter when an engine of the vehicle is started, and the second processor generating an output for the occupant of the vehicle based on the signal from the transmitter.
